(19) United States
(12) Patent Application Publication
(10) Pub. No.: US 2026/0180880 A1
(43) Pub. Date: Jun. 25, 2026

(54) Aggregation of Sampled Network Traffic

(71) Applicant: Arista Networks, Inc., Santa Clara, CA (US)

(72) Inventors: Sandip SHAH, Fremont, CA (US); John Ellington SCHIMMEL, Royse City, TX (US); Ryan Stacey IZARD, Seneca, SC (US); Michael Theodore STOLARCHUK, Ypsilanti, MI (US); Animesh PATCHA, Milpitas, CA (US)

(21) Appl. No.: 18/989,987

(22) Filed: Dec. 20, 2024

(51) Int. Cl. H04L 43/04; H04L 43/022; H04L 69/22

(52) U.S. Cl. CPC H04L 43/04; H04L 43/022; H04L 69/22

(57) ABSTRACT

Techniques for aggregating packet samples that are sent by network devices to a collector are provided. In certain embodiments, this aggregation involves summarizing the content of multiple packet samples that pertain to a particular network flow into a single, standardized flow record and transmitting batches of such flow records to the collector.

### BACKGROUND

Network management systems (NMSs) are software platforms that provide centralized control and monitoring of computer networks, such as production networks that support the day-to-day operations of organizations. One function commonly performed by an NMS involves receiving streams of packet samples from network devices in a production network, processing the packet samples to derive information regarding the network flows passing through those devices (e.g., observed flows, timing and counter information for each flow, etc.), and producing various reports and event notifications based on the derived flow information. However, in scenarios where the volume of packet samples sent to the NMS is very high, the NMS may be unable to process the samples in a timely manner and/or may fail to process certain samples at all. This can prevent the NMS from providing a correct view of the production network's usage and behavior.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example environment in accordance with certain embodiments of the present disclosure.

FIG. 2 depicts a version of the environment of FIG. 1 that includes an aggregator server/appliance in accordance with certain embodiments of the present disclosure.

FIGS. 3A and 3B depict aggregator workflows in accordance with certain embodiments of the present disclosure.

FIG. 4 depicts an example computer system in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for aggregating, via a server/appliance referred to as an aggregator, packet samples that are sent by network devices in a network to a collector (which may run an NMS or other similar software). In certain embodiments, this aggregation involves summarizing the content of multiple packet samples that pertain to a particular network flow into a single, standardized flow record and transmitting batches of such flow records to the collector.

With these techniques, the volume of network traffic that is delivered to, and thus needs to be ingested by, the collector can be significantly reduced. Further, because the aggregator is responsible for parsing the packet samples and summarizing the information contained therein into a standard flow-level format, the aggregator can facilitate interoperability between the collector and packet sample sources that employ different packet sampling protocols.

### 1. Example Environment and Solution Overview

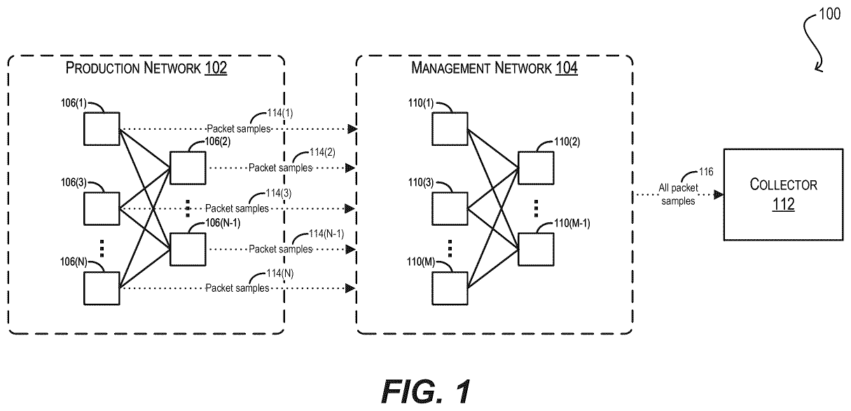

FIG. 1 is a simplified block diagram of an example environment 100 in which the techniques of the present disclosure may be implemented. As shown, environment 100 includes, among other things, a production network 102 that is communicatively coupled with a management network 104. Production network 102 is a computer network that supports the live, day-to-day operations of an organization and comprises a plurality of network devices (e.g., switches, routers, etc.) 106(1)-(N) that carry data traffic between computing resources (e.g., hosts) within network 102, as well as to/from external networks. Examples of such data traffic include application traffic, user data, and other operational communications.

Management network 104 is a computer network that supports the administration and management of production network 102 and comprises a plurality of network devices (e.g., switches, routers, etc.) 110(1)-(M) that carry management traffic between network 102 and one or more management entities. Examples of such management traffic include configuration commands, telemetry data (e.g., network device statistics, packet samples, application performance metrics, etc.), and operating system (OS) software updates.

In the example of FIG. 1, each network device 106 in production network 102 is connected to a management entity (referred to as a collector) 112 via management network 104 and is configured to send a stream of packet samples directly to collector 112 through network 104 (shown via reference numerals 114(1)-(N)). These packet samples are copies of network packets (or portions thereof) that are chosen (i.e., sampled) from the total data traffic passing through the network device for transmission to collector 112. Each network device 106 constructs and sends its stream of packets samples 114 in accordance with a particular packet sampling protocol supported by the device, such as sFlow, Generic Routing Encapsulation Encapsulated Telemetry (GREENT), Generic Routing Encapsulation Test Access Point (GRE-TAP), or the like.

Collector 112 is a computer system that is configured to (1) receive all of the streams of packet samples sent by network devices 106(1)-(N) via management network 104 (shown via reference numeral 116), (2) process the received packet samples to compute flow-level information/statistics regarding the data traffic passing through production network 102, and (3) generate reports, notifications, and/or other outputs based on the computed flow-level information/statistics, thereby providing network administrators a view into the usage and behavior of network 102. For example, the generated outputs can provide a list of applications sending and receiving traffic in production network 102, the number of network flows associated with each application, the timing and packet counts for each network flow, and so on. Collector 112 may perform some or all of these steps under the direction of a network management system (NMS) or other similar software that runs, either partially or entirely, on the collector.

While the topology shown in FIG. 1 is serviceable for the purpose of delivering packet samples from network devices 106(1)-(N) of production network 102 to collector 112, it also suffers from a couple of problems. First, the ingestion rate of collector 112 (or in other words the rate at which it can accept incoming packet samples) is fixed, while the number of network devices in production network 102 (and, thus the amount of packet sample traffic sent by these devices to collector 112) will scale upward as network 102 grows in size. If the volume of packet sample traffic sent by network devices 106(1)-(N) to collector 112 increases to a point where it exceeds the collector's ingestion rate, the collector will become overloaded and thus may fail to produce outputs that correctly characterize the usage/behavior of production network 102.

Second, in many cases management network 104 will have less bandwidth than production network 102 due to the typical nature of management traffic versus data traffic. Accordingly, management network 104 can be easily overwhelmed by large volumes of packet sample data, resulting in transmission delays and/or dropped packets.

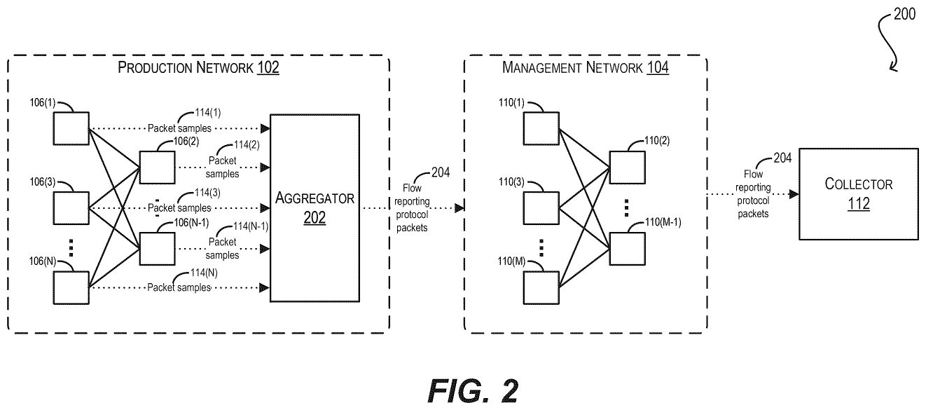

To address the foregoing and other related problems, FIG. 2 depicts an enhanced version 200 of environment 100 of FIG. 1 that includes a novel network server/appliance 202, referred to as an aggregator, within production network 102. Aggregator 202 may be implemented using a computer system comprising one or more general-purpose central processing units (CPUs) or using a specialized computing device comprising one or more application-specific integrated circuits (ASICs). As shown, aggregator 202 sits between network devices 106(1)-(N) of production network 102 and management network 104/collector 112.

At a high level, aggregator 202 can receive/ingest packet sample streams 114(1)-(N) from network devices 106(1)-(N) respectively (where the packet samples are formatted using the same or different packet sampling protocols) and can consolidate the packet samples into flow entries. For example, if aggregator 202 receives a set of packet samples that belong to a particular network flow F, the aggregator can create/update, in a local data structure, a flow entry for F based on the contents of those packet samples, where the flow entry includes various types of information regarding F (e.g., the total number of packets and bytes observed for F, the path taken by F through production network 102, etc.). Aggregator 202 can further convert, on a periodic basis, a group of flow entries into corresponding flow records that are formatted in accordance with a standardized flow reporting protocol (such as IPFIX), bundle the flow records into standardized flow reporting protocol packets (shown via reference numeral 204), and transmit flow reporting protocol packets 204 to collector 112 via management network 104. Collector 112 can then process the flow reporting protocol packets received from aggregator 202 to generate its reports/notifications/outputs pertaining to production network 102.

With this general approach, a number of benefits are achieved. First, because network devices 106(1)-(N) no longer send raw packet samples directly to collector 112 (instead, they send such packet samples to aggregator 202, which summarizes the information included therein into consolidated flow records for export to collector 112 via flow reporting protocol packets 204), this approach significantly reduces the amount of network traffic that needs to be transmitted over management network 104 and ingested by collector 112, thereby enabling the collector to efficiently and accurately produce outputs that are derived from very large volumes of packet sample data.

Second, because aggregator 202 can ingest packet samples that are formatted according to different packet sampling protocols (e.g., sFlow, GREENT, GRE-TAP, etc.) and export flow records based on those packet samples using a standardized flow reporting protocol (e.g., IPFIX), this approach facilitates interoperability between collector 112 and a variety of packet sample sources. For example, in a scenario where one or more of network devices 106(1)-(N) of production network 102 employ a proprietary packet sampling protocol, collector 112 does not need to know how to parse the packet samples sent by those devices because aggregator 202 will take care of that step; collector 112 need only understand the standard flow reporting protocol used by aggregator 202.

It should be appreciated that FIGS. 1 and 2 and the foregoing high-level solution description are illustrative and not intended to limit embodiments of the present disclosure. For example, although FIG. 2 depicts a single collector 112, in some embodiments multiple collectors may be deployed. In these embodiments, aggregator 202 may send a copy of each flow reporting protocol packet that it generates to each of the multiple collectors, thereby ensuring that each collector receives the same flow information. Alternatively, aggregator 202 may send certain flow reporting protocol packets to certain collectors, based on a configuration defining mappings between flows and collectors. For example, if a first collector is mapped to network flows A, B, and C and a second collector is mapped to network flows D, E, and F, aggregator 202 may send all flow reporting protocol packets comprising flow records for A, B, and C to the first collector and similarly send all flow reporting protocol packets comprising flow records for D, E, and F to the second collector.

### 2. Aggregator Workflows

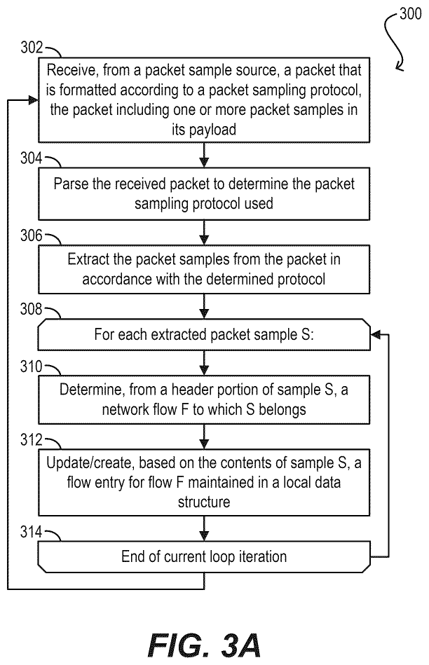

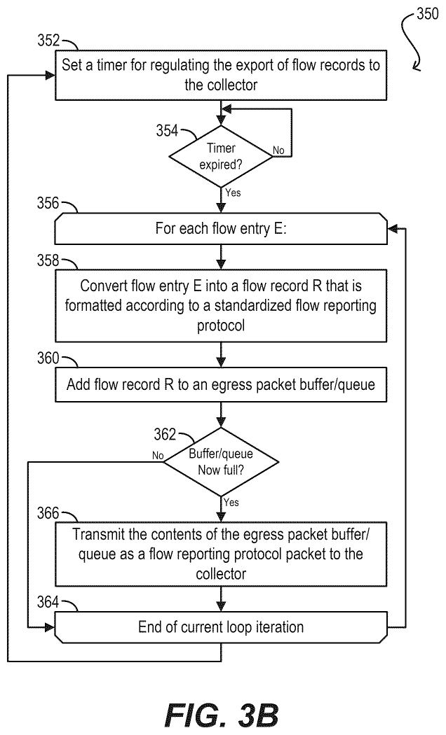

FIGS. 3A and 3B depict two concurrent workflows 300 and 350 that may be executed by aggregator 202 of FIG. 2 for ingesting and processing packet samples according to certain embodiments. Workflows 300 and 350 may be implemented in software (i.e., program code) that runs on one or more processors (e.g., CPUs) of aggregator 202 or in dedicated hardware (e.g., an ASIC).

Starting with step 302 of workflow 300 (FIG. 3A), aggregator 202 can receive from a packet sample source (e.g., a network device 106 in production network 102) a packet that is formatted according to a packet sampling protocol such as sFlow, GREENT, GRE-TAP, or the like, where the packet includes one or more packet samples in its payload. As mentioned previously, each of these packet samples is a copy of a network packet (or a portion thereof) that was sampled by the packet sample source from the data traffic passing through that device.

At steps 304 and 306, aggregator 202 can parse the received packet to determine the packet sampling protocol used and can extract the packet samples from the packet in accordance with the determined protocol. Aggregator 202 can then enter a loop for each extracted packet sample S (step 308).

Within the loop, aggregator 202 can determine, from a header portion of sample S, a network flow F to which S belongs (step 310). For example, in one set of embodiments aggregator 202 can make this determination based on the 5-tuple of [source Internet Protocol (IP) address, destination IP address, source port, destination port, protocol] found in the header portion.

Aggregator 202 can then update, based on the contents of sample S, a flow entry for flow F that the aggregator maintains in a local data structure, such as a hash table that is keyed by a flow identifier comprising the header 5-tuple (step 312). The types of information that are held in the flow entry and are updated via step 312 can include, e.g., the total number of packets and/or bytes observed for flow F, the path taken by flow F through production network 102, the approximate flow start time, the approximate flow end time, the minimum, maximum, and/or average times needed for packets in flow F to reach certain points in network 102, and so on. If sample S is the first packet sample seen by aggregator 202 for flow F, aggregator 202 can create (rather than update) the flow entry for F in the local data structure at step 312.

Finally, aggregator 202 can reach the end of the current loop iteration (step 314) and return to the top of the loop to process the next packet sample in the received packet. Upon processing all packet samples, aggregator 202 can return to step 302 to receive and process the next packet sent by a packet sample source.

Turning now to workflow 350 of FIG. 3B (which is executed concurrently with workflow 300), aggregator 202 can set a timer that is used to regulate the export of flow records to collector 112 (step 352) and, after some period of time, can check whether the timer has expired (step 354). For example, in a particular embodiment, this timer may be set to expire after 5 seconds. If aggregator 202 determines that the timer has not expired at step 354, the aggregator can repeat the check after waiting for an additional period of time.

On the other hand, if aggregator 202 determines that the time has expired at step 354, the aggregator can enter a loop for each flow entry E in its local data structure (step 356). Within this loop, the aggregator can convert flow entry E into a flow record R that is formatted according to a standardized flow reporting protocol (step 358). One example of such a protocol is IPFIX, although any standardized flow reporting protocol can be used.

Aggregator 202 can then add flow record R to an egress packet buffer or queue (step 360) and check whether the egress packet buffer/queue is now full (step 362). If the answer is no, aggregator 202 can proceed to the end of the current loop iteration (step 364) and return to the top of the loop to process the next flow entry.

However, if the answer at step 362 is yes (i.e., the egress packet buffer/queue is now full), aggregator 202 can transmit the contents of the egress packet buffer/queue as a single flow reporting protocol packet (e.g., an IPFIX packet) to collector 112 (step 366). Aggregator 202 can thereafter clear the egress packet buffer/queue (not shown), reach the end of the current loop iteration, and return to the top of the loop to process the next flow entry. Upon processing all flow entries, aggregator 202 can return to step 352 to reset the timer and repeat workflow 350.

### 4. Example Computer System

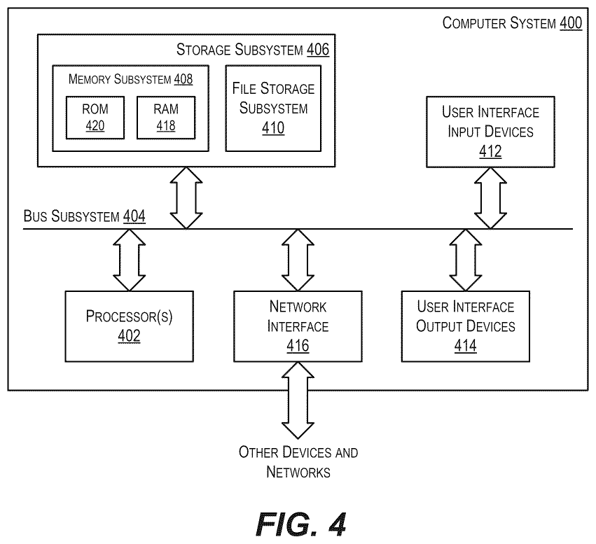

FIG. 4 is a simplified block diagram of an example computer system 400. In certain embodiments, computer system 400 (or a group of such systems) may be used to implement aggregator 202 of FIG. 2.

As shown in FIG. 4, computer system 400 includes one or more CPUs 402 that communicate with a number of peripheral devices via a bus subsystem 404. These peripheral devices include a storage subsystem 406 (comprising a memory subsystem 408 and a file storage subsystem 410), user interface input devices 412, user interface output devices 414, and a network interface subsystem 416.

Bus subsystem 404 provides a mechanism for letting the various components and subsystems of computer system 400 communicate with each other as intended. Although bus subsystem 404 is shown schematically as a single bus, alternative embodiments of the bus subsystem can utilize multiple buses.

Network interface subsystem 416 serves as an interface for communicating data between computer system 400 and other computing devices or networks. For example, network interface subsystem 416 may be used to communicatively couple computer system 400 with network devices 106(1)-(N) in production network 102, as well as with collector 112 via management network 104. Embodiments of network interface subsystem 416 can include wired (e.g., coaxial, twisted pair, or fiber optic) and/or wireless (e.g., Wi-Fi, cellular, Bluetooth, etc.) interfaces.

User interface input devices 412 can include a keyboard, pointing devices (e.g., mouse, trackball, touchpad, etc.), a scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 400.

User interface output devices 414 can include a display subsystem such as a flat-panel display or non-visual displays such as audio output devices, etc. In general, use of the term “output device” is intended to include all possible types of devices and mechanisms for outputting information from computer system 400.

Storage subsystem 406 includes a memory subsystem 408 and a file/disk storage subsystem 410. Subsystems 408 and 410 represent non-transitory computer-readable storage media that can store, in a non-transitory state, program code and/or data that provide the functionality of various embodiments described herein, including the workflows attributed to aggregator 202.

Memory subsystem 408 includes a number of memories including a main random-access memory (RAM) 418 for storage of instructions and data during program execution and a read-only memory (ROM) 420 in which fixed instructions may be stored. File storage subsystem 410 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 400 is illustrative and many other configurations having more or fewer components than computer system 400 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by an aggregator appliance that is communicatively coupled with a collector and with a plurality of network devices in a first network, the method comprising:
receiving, from a network device in the plurality of network devices, a packet that is formatted according to a packet sampling protocol, the packet including one or more packet samples;
parsing the packet to extract the one or more packet samples; and
for each packet sample:
determining a network flow to which the packet sample belongs; and
updating, based on contents of the packet sample, information held in a flow entry for the network flow, the flow entry being maintained in a data structure of the aggregator appliance.

2. The method of claim 1 further comprising, on a periodic basis:
creating a flow record based on the information in the flow entry, the flow record being formatted according to a flow reporting protocol; and
adding the flow record to an egress packet buffer or queue.

3. The method of claim 2 further comprising:
upon determining that the egress packet buffer or queue is full, transmitting contents of the egress packet buffer or queue as a flow reporting protocol packet to the collector, the flow reporting protocol packet being formatted according to the flow reporting protocol.

4. The method of claim 2 wherein the flow reporting protocol is IPFIX.

5. The method of claim 3 wherein the flow reporting protocol packet is transmitted to the collector via a second network different from the first network.

6. The method of claim 5 wherein the aggregator appliance resides in the first network and is communicatively coupled with the second network.

7. The method of claim 5 wherein the first network is a production network and the second network is a management network.

8. The method of claim 1 wherein parsing the packet includes determining the packet sampling protocol.

9. The method of claim 1 wherein the packet sampling protocol is a protocol that is not supported by the collector.

10. The method of claim 1 wherein the information held in the flow entry includes timing, counter, and/or path information pertaining to the network flow.

11. A computer system comprising:
a processor; and
a computer-readable storage medium having stored thereon program code that, when executed by the processor, causes the processor to:
receive, from a network device in a plurality of network devices, a packet that is formatted according to a packet sampling protocol, the packet including one or more packet samples;
parse the packet to extract the one or more packet samples; and
for each packet sample:
determine a network flow to which the packet sample belongs; and
update, based on contents of the packet sample, information held in a flow entry for the network flow, the flow entry being maintained in a data structure of the computer system.

12. The computer system of claim 11 wherein the program code further causes the processor to, on a periodic basis:
create a flow record based on the information in the flow entry, the flow record being formatted according to a flow reporting protocol; and
add the flow record to an egress packet buffer or queue.

13. The computer system of claim 12 wherein the program code further causes the processor to:
upon determining that the egress packet buffer or queue is full, transmit contents of the egress packet buffer or queue as a flow reporting protocol packet to a collector, the flow reporting protocol packet being formatted according to the flow reporting protocol.

14. The computer system of claim 12 wherein the flow reporting protocol is IPFIX.

15. The computer system of claim 13 wherein the computer system resides in a first network and is communicatively coupled with a second network different from the first network.

16. The computer system of claim 15 wherein the flow reporting protocol packet is transmitted to the collector via the second network.

17. The computer system of claim 15 wherein the first network is a production network and the second network is a management network.

18. The computer system of claim 11 wherein parsing the packet includes determining the packet sampling protocol.

19. The computer system of claim 13 wherein the packet sampling protocol is a protocol that is not supported by the collector.

20. A method comprising:
receiving, by a computer system, a packet sample from a network device in a first network;
determining a network flow to which the packet sample belongs;
creating, based on contents of the packet sample, a flow record for the network flow, the flow record being formatted according to a standardized flow reporting protocol; and
sending the flow record to a management entity associated with the first network.
